(19) United States
(12) Patent Application Publication
(10) Pub. No.: US 2026/0136308 A1
(43) Pub. Date: May 14, 2026

(54) NEW RADIO MEASUREMENTS WITH LIMITED SPECTRUM

(71) Applicant: NOKIA TECHNOLOGIES OY, Espoo (FI)

(72) Inventors: Rafhael MEDEIROS DE AMORIM, Aalborg (DK); Jani-Pekka KAINULAINEN, Cambridgeshire (GB); Jedrzej STANCZAK, Wroclaw (PL); Lars DALSGAARD, Oulu (FI)

(21) Appl. No.: 18/942,274

(22) Filed: Nov. 8, 2024

(51) Int. Cl. H04W 56/00; H04W 8/24

(52) U.S. Cl. CPC H04W 56/001; H04W 8/24

(57) ABSTRACT

Systems, methods, apparatuses, and computer program products for new radio measurements with a limited spectrum. A method may include transmitting, to a network element in response to a capability inquiry, capability information including an operational capability of a user equipment under a reduced bandwidth, a long periodicity, or a network scenario based on an operating status of the network element. The method may also include receiving, from the network element in response to the capability information, a configuration including at least one of a reduced bandwidth or a periodicity configuration of the user equipment. The method may further include performing, based on the configuration, a measurement over a synchronization signal block. In addition, the method may include reporting the measurement over the synchronization signal block to the network element.

### FIELD

Some example embodiments may generally relate to mobile or wireless telecommunication systems, such as Long Term Evolution (LTE) or fifth generation (5G) new radio (NR) access technology, or 5G beyond, or sixth generation (6G) access technology, or other communications systems. For example, certain example embodiments may relate to new radio measurements with a limited spectrum.

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, fifth generation (5G) radio access technology or new radio (NR) access technology and/or sixth generation (6G) radio access technology. Fifth generation (5G) and sixth generation (6G) wireless systems refer to the next generation (NG) of radio systems and network architecture. 5G and 6G network technology is mostly based on new radio (NR) technology, but the 5G/6G (or NG) network can also build on E-UTRAN radio. It is estimated that NR may provide bitrates on the order of 10-20 Gbit/s or higher, and may support at least enhanced mobile broadband (eMBB) and ultra-reliable low-latency communication (URLLC) as well as massive machine-type communication (mMTC). NR is expected to deliver extreme broadband and ultra-robust, low-latency connectivity and massive networking to support the Internet of Things (IoT).

### SUMMARY

Some example embodiments may be directed to a method. The method may include determining, in response to a capability inquiry from a network element, whether to transmit capability information of a user equipment. The method may also include receiving, from the network element based on the determination, a measurement configuration for the user equipment. The method may further include performing, based on the measurement configuration, a measurement over a synchronization signal block, wherein performing the measurement may be dependent upon at least one condition. In addition, the method may include determining a set of requirements applicable for the user equipment to complete the measurement depending on the at least one condition being met.

Other example embodiments may be directed to an apparatus. The apparatus may include at least one processor and at least one memory storing instructions that, when executed by a processor, cause the apparatus at least to determine, in response to a capability inquiry from a network element, whether to transmit capability information of the apparatus. The apparatus may also be caused to receive, from the network element based on the determination, a measurement configuration for the user equipment. The apparatus may further be caused to perform, based on the measurement configuration, a measurement over a synchronization signal block, wherein performing the measurement may be dependent upon at least one condition. In addition, the apparatus may be caused to determine a set of requirements applicable for the apparatus to complete the measurement depending on the at least one condition being met.

Other example embodiments may be directed to an apparatus. The apparatus may include means for determining, in response to a capability inquiry from a network element, whether to transmit capability information of the apparatus. The apparatus may also include means for receiving, from the network element based on the determination, a measurement configuration for the user equipment. The apparatus may further include means for performing, based on the measurement configuration, a measurement over a synchronization signal block, wherein performing the measurement may be dependent upon at least one condition. In addition, the apparatus may include means for determining a set of requirements applicable for the apparatus to complete the measurement depending on the at least one condition being met.

In accordance with other example embodiments, a non-transitory computer readable medium may be encoded with instructions that may, when executed in hardware, perform a method. The method may include determining, in response to a capability inquiry from a network element, whether to transmit capability information of a user equipment. The method may also include receiving, from the network element based on the determination, a measurement configuration for the user equipment. The method may further include performing, based on the measurement configuration, a measurement over a synchronization signal block, wherein performing the measurement may be dependent upon at least one condition. In addition, the method may include determining a set of requirements applicable for the user equipment to complete the measurement depending on the at least one condition being met.

Other example embodiments may be directed to a computer program product that performs a method. The method may include determining, in response to a capability inquiry from a network element, whether to transmit capability information of a user equipment. The method may also include receiving, from the network element based on the determination, a measurement configuration for the user equipment. The method may further include performing, based on the measurement configuration, a measurement over a synchronization signal block, wherein performing the measurement may be dependent upon at least one condition. In addition, the method may include determining a set of requirements applicable for the user equipment to complete the measurement depending on the at least one condition being met.

Other example embodiments may be directed to an apparatus that may include circuitry configured to determine, in response to a capability inquiry from a network element, whether to transmit capability information of the apparatus. The apparatus may also include circuitry configured to receive, from the network element based on the determination, a measurement configuration for the user equipment. The apparatus may further include circuitry configured to perform, based on the measurement configuration, a measurement over a synchronization signal block, wherein performing the measurement may be dependent upon at least one condition. In addition, the apparatus may include circuitry configured to determine a set of requirements applicable for the apparatus to complete the measurement depending on the at least one condition being met.

Further example embodiments may be directed to a method. The method may include receiving, from a user equipment in response to a capability inquiry, capability information of the user equipment. The method may also include transmitting, to the user equipment based on the capability information, a measurement configuration for the user equipment. The method may further include receiving, from the user equipment, a measurement report comprising a measurement over a synchronization signal block based on at least one condition.

Other example embodiments may be directed to an apparatus. The apparatus may include at least one processor and at least one memory including computer program code. The at least one memory and the computer program code may be configured to, with the at least one processor, cause the apparatus at least to receive, from a user equipment in response to a capability inquiry, capability information of the user equipment. The apparatus may also be caused to transmit, to the user equipment based on the capability information, a measurement configuration for the user equipment. The apparatus may further be caused to receive, from the user equipment, a measurement report comprising a measurement over a synchronization signal block based on at least one condition.

Other example embodiments may be directed to an apparatus. The apparatus may include means for receiving, from a user equipment in response to a capability inquiry, capability information of the user equipment. The apparatus may also include means for transmitting, to the user equipment based on the capability information, a measurement configuration for the user equipment. The apparatus may further include means for receiving, from the user equipment, a measurement report comprising a measurement over a synchronization signal block based on at least one condition.

In accordance with other example embodiments, a non-transitory computer readable medium may be encoded with instructions that may, when executed in hardware, perform a method. The method may include receiving, from a user equipment in response to a capability inquiry, capability information of the user equipment. The method may also include transmitting, to the user equipment based on the capability information, a measurement configuration for the user equipment. The method may further include receiving, from the user equipment, a measurement report comprising a measurement over a synchronization signal block based on at least one condition.

Other example embodiments may be directed to a computer program product that performs a method. The method may include receiving, from a user equipment in response to a capability inquiry, capability information of the user equipment. The method may also include transmitting, to the user equipment based on the capability information, a measurement configuration for the user equipment. The method may further include receiving, from the user equipment, a measurement report comprising a measurement over a synchronization signal block based on at least one condition.

Other example embodiments may be directed to an apparatus that may include circuitry configured to receive, from a user equipment in response to a capability inquiry, capability information of the user equipment. The apparatus may also include circuitry configured to transmit, to the user equipment based on the capability information, a measurement configuration for the user equipment. The apparatus may further include circuitry configured to receive, from the user equipment, a measurement report comprising a measurement over a synchronization signal block based on at least one condition.

Some example embodiments may be directed to a method. The method may include to transmitting, to a network element in response to a capability inquiry, capability information including an operational capability of a user equipment under a reduced bandwidth, a long periodicity, or a network scenario based on an operating status of the network element. The method may also include receiving, from the network element in response to the capability information, a configuration including at least one of a reduced bandwidth or a periodicity configuration of the user equipment. The method may further include performing, based on the configuration, a measurement over a synchronization signal block. In addition, the method may include reporting the measurement over the synchronization signal block to the network element.

Other example embodiments may be directed to an apparatus. The apparatus may include at least one processor and at least one memory storing instructions that, when executed by a processor, cause the apparatus at least to transmit, to a network element in response to a capability inquiry, capability information including an operational capability of the apparatus under a reduced bandwidth, a long periodicity, or a network scenario based on an operating status of the network element. The apparatus may also be caused to receive, from the network element in response to the capability information, a configuration including at least one of a reduced bandwidth or a periodicity configuration of the apparatus. The apparatus may further be caused to perform, based on the configuration, a measurement over a synchronization signal block. In addition, the apparatus may be caused to report the measurement over the synchronization signal block to the network element.

Other example embodiments may be directed to an apparatus. The apparatus may include means for transmitting to a network element in response to a capability inquiry, capability information including an operational capability of the apparatus under a reduced bandwidth, a long periodicity, or a network scenario based on an operating status of the network element. The apparatus may also include means for receiving, from the network element in response to the capability information, a configuration including at least one of a reduced bandwidth or a periodicity configuration of the apparatus. The apparatus may further include means for performing, based on the configuration, a measurement over a synchronization signal block. In addition, the apparatus may include means for reporting the measurement over the synchronization signal block to the network element.

In accordance with other example embodiments, a non-transitory computer readable medium may be encoded with instructions that may, when executed in hardware, perform a method. The method may include transmitting, to a network element in response to a capability inquiry, capability information including an operational capability of a user equipment under a reduced bandwidth, a long periodicity, or a network scenario based on an operating status of the network element. The method may also include receiving, from the network element in response to the capability information, a configuration including at least one of a reduced bandwidth or a periodicity configuration of the user equipment. The method may further include performing, based on the configuration, a measurement over a synchronization signal block. In addition, the method may include reporting the measurement over the synchronization signal block to the network element.

Other example embodiments may be directed to a computer program product that performs a method. The method may include transmitting, to a network element in response to a capability inquiry, capability information including an operational capability of a user equipment under a reduced bandwidth, a long periodicity, or a network scenario based on an operating status of the network element. The method may also include receiving, from the network element in response to the capability information, a configuration including at least one of a reduced bandwidth or a periodicity configuration of the user equipment. The method may further include performing, based on the configuration, a measurement over a synchronization signal block. In addition, the method may include reporting the measurement over the synchronization signal block to the network element.

Other example embodiments may be directed to an apparatus that may include circuitry configured to transmit, to a network element in response to a capability inquiry, capability information including an operational capability of the apparatus under a reduced bandwidth, a long periodicity, or a network scenario based on an operating status of the network element. The apparatus may also include circuitry configured to receive, from the network element in response to the capability information, a configuration including at least one of a reduced bandwidth or a periodicity configuration of the apparatus. The apparatus may further include circuitry configured to perform, based on the configuration, a measurement over a synchronization signal block. In addition, the apparatus may include circuitry configured to report the measurement over the synchronization signal block to the network element.

### BRIEF DESCRIPTION OF THE DRAWINGS

For proper understanding of example embodiments, reference should be made to the accompanying drawings, wherein:

FIG. 1 illustrates an example synchronization signal block (SSB) structure.

FIG. 2 illustrates an example SSB which has been punctured.

FIG. 3 illustrates an example signal flow diagram, according to certain example embodiments.

FIG. 4 illustrates an example of another signal flow diagram, according to certain example embodiments.

FIG. 5 illustrates an example flow diagram of a method, according to certain example embodiments.

FIG. 6 illustrates an example flow diagram of another method, according to certain example embodiments.

FIG. 7 illustrates an example flow diagram of a further method, according to certain example embodiments.

FIG. 8 illustrates a set of apparatuses, according to certain example embodiments.

### DETAILED DESCRIPTION

It will be readily understood that the components of certain example embodiments, as generally described and illustrated in the figures herein, may be arranged and designed in a wide variety of different configurations. The following is a detailed description of some example embodiments of systems, methods, apparatuses, and computer program products for new radio (NR) measurements with a limited spectrum. For example, certain example embodiments may relate to handling pruned synchronization signal blocks (SSBs) in a less than 5 MHz channel bandwidth.

The features, structures, or characteristics of example embodiments described throughout this specification may be combined in any suitable manner in one or more example embodiments. For example, the usage of the phrases “certain embodiments,” “an example embodiment,” “some embodiments,” or other similar language, throughout this specification refers to the fact that a particular feature, structure, or characteristic described in connection with an embodiment may be included in at least one embodiment. Thus, appearances of the phrases “in certain embodiments,” “an example embodiment,” “in some embodiments,” “in other embodiments,” or other similar language, throughout this specification do not necessarily refer to the same group of embodiments, and the described features, structures, or characteristics may be combined in any suitable manner in one or more example embodiments. Further, the terms “base station”, “cell”, “node”, “gNB”, “network” or other similar language throughout this specification may be used interchangeably.

As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

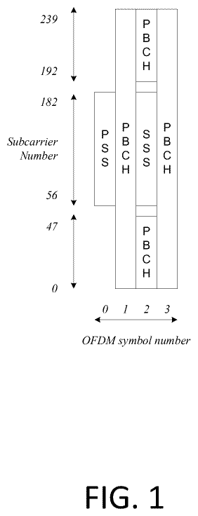

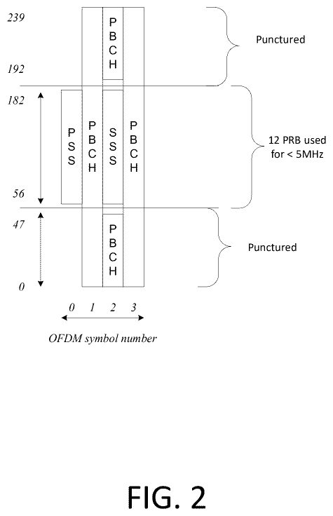

FIG. 1 illustrates an example synchronization signal block (SSB) structure, and FIG. 2 illustrates an example SSB which has been punctured. As illustrated in FIGS. 1 and 2, the SSB may be supported in a channel bandwidth of less than 5 MHz. The SSB may be capable of carrying specific signals for establishing downlink (DL) synchronization, and may help user equipments (UEs) synchronize with the network. The SSB may be involved in initial cell detection, timing synchronization, and frequency alignment. The specifications of the 3rd Generation Partnership Project (3GPP) describe SSBs that are capable of carrying specific signals for establishing downlink (DL) synchronization.

As illustrated in FIGS. 1 and 2, the SSB may include a primary synchronization signal (PSS), a secondary synchronization signal (SSS), and a physical broadcast channel (PBCH). The PSS provides a coarse timing and frequency synchronization, and includes a predefined sequence of complex-valued symbols transmitted over a specific frequency range. On the other hand, the SSS provides synchronization and cell identification, and carries a cell identity group. The SSS also helps determine the exact physical cell ID of a serving cell, where the physical cell ID may include a unique identifier assigned to each cell within the network. UEs may use the physical cell ID to differentiate neighboring cells and synchronize with the correct cell.

Each SS Block within a SS Block set (e.g., all of the SS Blocks within a 5 ms period of the SSB transmission) may be assigned a unique number starting from 0, and increasing by 1. This number may reset to 0 in a next SS block set (e.g., next 5 ms span after the SSB transmission cycle (e.g., 20 ms)). The unique number (e.g., SS Block index) may be informed to the UE via a PBCH demodulation reference signal (DMRS), or a PBCH payload.

3GPP introduces less than 5 MHz channel bandwidth for SSB transmission. In some examples, the PBCH SSB may be 12 physical resource blocks (PRBs) for bands other than n100. The band n100 may support both 12 PRB and 20 PRB SSB. 3GPP also considers system parameters for a channel bandwidth of less than 5 MHz for NR non-terrestrial networks (NTN), where NR-NTN bands may include n255, n256, and n254. In some cases, NTN may be introduced with a potentially higher SSB periodicity in a standalone deployment for NTN scenarios under the justification that satellites are power limited (due to energy constraints in the satellite). NTNs may also disable some cells periodically to provide coverage in a larger area. Under this coverage enhancement for satellites with saving power features, current RANI considers to increase the SSB periodicity from 160 ms up to 320/640 ms.

The introduction of less than 5 MHz solutions may lead to the SSB being pruned/punctured, as illustrated in FIG. 2, when transmitted by the network. In a less than 5 MHz channel bandwidth, the total SSB index reading time increases, which results in the minimum requirements increasing to compensate for the loss of PBCH bandwidth. The minimum requirements may include the requirements specified that all the UEs implementing a feature would need to at least pass to be able to be compliant with the NR system. These requirements may made with a certain assumptions and simulated in such a way that the requirements are meaningful for a given scenario. For example, for intra and inter-frequency neighbor cell measurements, two more periods of the SSB transmission may be included in the minimum requirements.

Currently, a less than 5 MHz channel bandwidth is considered for NTNs to enable usage in narrow satellite spectrum bands. In the less than 5 MHz channel bandwidth, SSB periodicity may be assumed to be 20 ms. Thus, adding two samples to the requirements where the SSB index reading is required results in an extra 40 ms of overhead.

In NTN systems, the SSB periodicity may be longer than the regular 20 ms, which may correspond to the usual assumption in NR system, for instance 320 ms or 640 ms. Other NTN relaxations may be needed for measurements (e.g., for example, distributed measurement samples across multiple satellites), which may cause the NTN UE to have a total time to complete the measurements above a few seconds, which is not an acceptable delay for cellular networks.

Introducing less than 5 MHz to NTN systems may cause significant measurement time overhead as the assumption of SSB periodicity may be different, for instance, as one example, instead of using 20 ms SSB periodicity, 160 ms or 320 ms can be used. Thus, as described herein, certain example embodiments may provide a solution on how to improve performance (while considering system parameters e.g., measurement period, or radio conditions) of NR measurements in a less than 5 MHz system, for instance, when the measurement periodicity is long. According to certain example embodiments, it may also be possible to handle the pruned/punctured SSB, and signal detection in a less than 5 MHz channel bandwidth over NTN while still enabling the UE to complete measurements in a timely manner.

Certain example embodiments may provide UE behavior together with a capability and network signaling for fast measurements under modified SSB conditions. Certain example embodiments may also provide the ability to differentiate the applicability of requirements for the UE with and without the capability. In certain example embodiments, there may be certain capability conditions that indicate that some UEs are capable of completing measurements earlier than legacy UEs under normal requirements. These UEs may indicate a special capability, and implement measurements with a reduced number of samples and comply with the new UE requirements for fast measurements either when the capability of performing fast measurements is supported and/or when the capability of performing fast measurements is configured. In some example embodiments, the measurements implemented with the reduced number of samples and complying with the new UE requirements may include neighbor cell measurements using a reduced (e.g., punctured) version of the SSB.

In certain example embodiments, certain conditions may be applicable for fast measurements over pruned/punctured SSBs. For instance, one condition may include the UE performing measurements in better radio conditions such as when a side condition is X dB, where X is greater than a legacy side condition. For example, in some example embodiments, X may be −6 dB, −4 dB, or −2 dB. In other example embodiments, another condition may include the UE supporting mechanism to incrementally improve measurement performance by accumulating periodical measurement samples. Such mechanisms may be called soft combining mechanisms. In some scenarios the impact of the soft combining mechanism may be an additional 3 dB over non-soft combining methods. In other example embodiments, another condition may include the network being able to assume power boosting of the non-punctured part of the SSB. For instance, power boosting of the SSB may include increasing the transmit power of the SSB while decreasing the transmit power in other channels (without changing the total average transmit power), but increasing the robustness of the SSB. According to certain example embodiments, with at least the above conditions, it may be possible to reduce the number of measurement samples when the UE supports fast measurement capability and/or is configured with a fast measurement condition.

In certain example embodiments, when the cell operates on reduced bandwidth measurements, such as 12 PRB SSB, the UE may report measurements when the improved side condition is satisfied such that the UE may perform single shot measurements. When UE is performing a single shot measurement, the UE is only reading one sample, to gain a synchronization to a level where the UE is capable of meeting, for instance, timing requirements associated with the uplink transmissions. Single shot measurements may require good radio conditions to be performed, such as, for example, satisfying the side condition. In some example embodiments, when the UE is configured with a long SSB periodicity such as, for example, 320 ms or 640 ms in an NTN scenario, the UE may report measurements when the side condition is satisfied such that the UE may perform single shot measurements. In certain example embodiments, when the UE is configured with a long SSB periodicity, the UE may use a different receiver chain to perform the single shot measurements to satisfy single shot measurement criteria as described above. In other example embodiments, when the UE is configured with a long SSB periodicity, the UE may perform the single shot measurements at every SSB periodicity to maintain synchronization. In further example embodiments, when the UE is configured with a long SSB periodicity, the UE may store the previous samples and perform extra receiver processing including, for example, soft combining if the previous and the current SSB measurements are within a certain margin.

According to certain example embodiments, the fast measurements may be defined as measurements performed over a punctured SSB or reference signal structure (e.g., similar to PSS/SSS). Although fast measurements may be applicable for operations in less than 5 MHz carriers, it is not limited to this scenario. For example, in some example embodiments, the fast measurements may be applied to PSS/SSS measurements. As such, the SSB or reference signal to be measured may be modified from a default configuration, and may cause slower measurements to be performed. For example, in a less than 5 MHz operation, the measurements may correspond to PSS/SSS measurements that are punctured, or in other example embodiments, the PSS/SSS parts of the SSB measurements may be considered for the measurements.

In certain example embodiments, certain conditions may be applicable to fulfill fast measurements. For instance, in some example embodiments, the UE may comply with the requirements for fast measurements when the side condition is X dB. In certain example embodiments, the requirements may include intra- and inter-frequency measurements based on SSB periodicity and with reduced amount of samples when compared to the requirements without fast measurement capability, which are specified in 3GPP TS 38.133 specification (e.g., for UE operating on a cell supporting 12 PRB SSB). Compared to the baseline, the number of samples is reduced, hence the measurements may be “faster.” However, faster may be considered within the same SSB periodicity. For instance, if the UE performs 1 measurement with 320 ms SSB periodicity, this would mean that the UE is measuring 1 sample an it takes 320 ms. On the other hand, if the UE is measuring 2 samples, this would take 640 ms, hence performing one measurement may result in the measurement becoming faster. The comparison between fast and slow, therefore may be made with the same reference signal periodicity, and instead of optimizing the radio conditions, the optimization and improvement may be made on the time domain. According to some example embodiments, the side condition may be, for example, −2 dB for a known cell, 2 dB for a known cell, or 2 dB for an unknown cell. The dB value for a cell may be the same or larger than the legacy value depending on whether the condition is applied with other fast measurement conditions.

According to some example embodiments, the condition may include when the UE is performing measurements, for instance PSS/SSS measurements with reduced bandwidth such as 12 PRB, the UE may be expected to perform soft combining across the measurement samples. A measurement sample may be, for instance, one SSB. According to other example embodiments, the condition may be applicable to the network where the network applies a power boosting for the PSS/SSS of the SSB.

In certain example embodiments, fast measurements may be applicable in NR handover procedures. For instance, when the UE receives a radio resource control (RRC) message implying handover, the UE may be read to start the transmission of a new uplink (UL) physical random access channel (PRACH) channel within D_{handover} seconds from the end of a last transmission time interval (TTI) containing the RRC command. The D_{handover} may correspond to the maximum RRC procedure delay plus an interruption time Tᵢₙₜₑᵣᵣᵤₚₜ. The interruption time Tᵢₙₜₑᵣᵣᵤₚₜ may correspond to the time between an end of a last TTI containing the RRC command on an old physical downlink shared channel (PDSCH) and the time the UE starts transmission of the new PRACH, excluding the RRC procedure delay. When the intra-frequency or inter-frequency handover is commanded, the interruption time may be less than Tᵢₙₜₑᵣᵣᵤₚₜ, where Tᵢₙₜₑᵣᵣᵤₚₜ=T_{search}+T_{IU}+T_{processing}+T_{Δ}+T_{margin} ms. T_{search} may represent the time required to search the target cell when the target cell is not already known when the handover command is received by the UE. If the target cell is known, then T_{search}=0 ms. If the target cell is an unknown intra-frequency cell and signal quality is sufficient for successful cell detection on the first attempt, then T_{search}=Tᵣₛ+2 ms. If the target cell is an unknown intra-frequency cell and the target cell Es/Iot≥−2 dB, where Es/lot indicates Energy Spectral Density per Interference plus Noise Temperature, then T_{search}=Tᵣₛ ms. Additionally, if the target cell is an unknown inter-frequency cell and the signal quality is sufficient for successful cell detection on the first attempt, then T_{search}=[3*Tᵣₛ+2] ms. Regardless of whether discontinuous reception (DRX) is in use by the UE, T_{search} may still be based on non-DRX target cell search times. If the measured SSB is the target SSB for handover of the target cell, T_{search}=0 ms. If the measured SSB and the target SSB for handover belong to the NR target cell, and if the UE supports non-cell-defining (ncd)-SSB-BWP-Wor-r18, T_{search}=Tᵣₛ ms provided any one of the certain conditions is satisfied.

In one example embodiment, the condition may include a situation where the cell defining (CD) SSB in an initial DL bandwidth part (BWP) is the measured SSB and non-cell defining (NCD)-SSB in the first active DL BWP is the target SSB for handover. Another condition may include the NCD-SSB in a DL BWP is the measured SSB and cell-defining (CD)-SSB in the initial DL BWP is the target SSB for handover. Both measured SSB and the target SSB for handover may be NCD-SSB within different DL BWPs. If the target cell is an unknown inter-frequency cell and T_{search}=3*Tᵣₛ ms, the target cell Es/lot≥−2 dB.

In the above equation, TA may correspond to the time for fine time tracking and acquiring full timing information of the target cell (T_{Δ}=Tᵣₛ). Further, T_{IU} is the interruption uncertainty acquiring the first available PRACH occasion in the new cell. Additionally, T_{IU} may be up to X*10+10 ms. In the above equation, Tᵣₛ may correspond to the SSB-based radio resource management (RRM) measurement timing configuration (SMTC) period of the target NR cell if the UE has been provided with an SMTC configuration for the target cell prior to or in the handover command. Otherwise, Tᵣₛ may be the target cell SSB transmission period, if provided. If the UE is not provided with an SMTC configuration or SSB transmission period, the requirement may be applied with Tᵣₛ=5 ms unless the SSB transmission periodicity is not 5 ms. If the UE is provided with both SMTC configuration and SSB transmission period, the requirements may be based on the SMTC periodicity. In some cases, the value of T_{IU} may depend upon the PRACH configuration used in the target cell.

In certain example embodiments, T_{Δ}=Tᵣₛ for both known and unknown target cells operating with a 20 PRB SSB bandwidth, and T_{Δ}=3*Tᵣₛ for both known and unknown target cells operating with a 12 PRB SSB bandwidth. According to certain example embodiments, if the target cell is an unknown inter-frequency cell and T_{search}=3*Tᵣₛ ms if the target cell Es/lot≥0 dB, and the UE supports the capability for fast measurements under punctured SSBs, then TA may represent the time for fine time tracking and acquiring full timing information of the target cell. Additionally, in other example embodiments, T_{Δ}=1*Tᵣₛ for both known and unknown target cells operating with a 12 PRB SSB bandwidth.

According to certain example embodiments, a UE capability may be signaled to the network (e.g., gNB/cell), and may be used by the network to determine whether the UE is capable of performing fast measurements. According to other example embodiments, the capability to perform fast measurements may be applicable to all UEs. Additionally, the requirements for fast measurements may be differentiated depending on the fulfillment of a different side-condition (e.g., “fast measurements” side condition). In some cases, also the side condition where the UE is capable of performing fast measurements may be indicated in the capability. This may be, for instance, depending on the UE receiver and RF implementation. This again may impact the capability of the UE to perform the single-shot measurements, for instance.

In certain example embodiments, differentiation of the applicability of the fast requirements may be based on a network configuration. For example, new dedicated network configuration for fast measurement may be introduced. In certain example embodiments, the network configuration may include a new measurement object (MO) for fast measurement configuration, or an existing measurement object may be enhanced to include fast measurement information.

In other example embodiment the UE may have a set of bands it indicates the fast measurement capability, and according to the set of bands, the network may configure the UE with a list of fast measurement carriers (e.g., in a new or existing measurement object only if the carrier is within the supported band or in the supported band combinations). According to certain example embodiments, carriers provided by the network may be distinguished based on the frequency configuration provided by the network, this may be for instance Absolute Radio Frequency Channel Number (ARFCN) or a value derived from it. This way, a carrier may refer to a specific frequency band location to which the reference signal is, and fast measurements that are configured may be indicated by the network as a list. In further example embodiments, the network configuration, or the network configuration with a flag may configure the UE to perform fast measurements for reduced bandwidth measurements such as 12 PRB SSB. According to certain example embodiments, when the UE is configured with a specific SSB periodicity, the fast measurement may be applied.

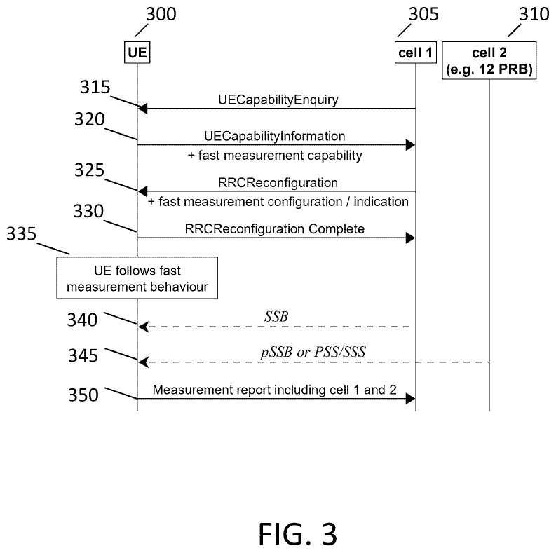

FIG. 3 illustrates an example signal flow diagram, according to certain example embodiments. At 315, cell 1 305 transmits a request/inquiry to the UE 300 for UE capability information. At 320, the UE 300 responds to the request from cell 1 305 by transmitting UE capability information. However, in some example embodiments, the fact that the UE 300 may have a capability does not necessarily mean that the UE 300 transmits its capability. According to certain example embodiments, the UE capability information may include a fast measurement capability of the UE. Fast measurement capability may refer to a special signaling indicated by the UE via UE capability information exchange prior to connection establishment. Before the capability information exchange, the UE may already know that the reduced bandwidth measurements are in use due to specific band being supported and/or searched by the UE. After the UE initiates the first connection to the network, a capability information may be exchanged, and from which the network knows that the UE supports fast measurement capability. According to certain example embodiments, the UE's fast measurement capability may be dependent upon the various UE and network conditions described herein. At 325, cell 1 305 transmits an RRC reconfiguration to the UE 300 in response to receiving the UE capability information and fast measurement capability. In certain example embodiments, the RRC reconfiguration may include a fast measurement configuration or indication for configuring the UE to perform fast measurements. In other example embodiments, the cell 1 305 may not necessarily configure the fast measurements, and may instead just configure the measurement. Whether the UE 300 finishes the measurement according to a regular requirement or a fast measurement requirement may depend on certain conditions described herein. In some example embodiments, fast measurements may be completed in a shorter requirement for time to complete the measurement. At 330, the UE transmits an RRC reconfiguration complete message to cell 1 305, indicating that the UE 300 has now established a connection with cell 1 305.

At 335, the UE 300 follows fast measurement behavior to perform fast measurement. Measurement behavior may be considered to be fast if the UE 300 follows the requirements associated with the capability. In this case, for instance, the number of samples is reduced from the baseline requirements. In certain example embodiments, when the UE 300 is supporting fast measurement capability, the UE 300 may follow the associated behaviour and pass the corresponding test cases. By following the associated behavior and passing the corresponding test cases, it may be possible to ensure the UE performance in the field when the capability is supported. At 340, cell 1 305 transmits an SSB to the UE 300, and at 345, cell 2 310 transmits pSSB (pruned/punctured SSB) or PSS/SSS to the UE 300. In cell 1 305, the SSB or pSSB may also be a smaller bandwidth reference signal than the regular SSB. For example, the bandwidth may be reduced, but the signal may be extended in the time domain (i.e., more slots may be used). At 350, the UE 300 performs fast measurement of the SSB, PSSB, or PSS/SSS according to the fast measurement configuration, and transmits a measurement report which may include, for instance reference signal received power/reference signal received quality (RSRP/RSRQ) values of the measurements performed on cell/beam 1 305 and cell/beam 2 310.

In certain example embodiments, the UE measurement behavior may change between a normal SSB periodicity and a long SSB periodicity. For instance, the UE measurement behavior may change when the SSB periodicity is 20 ms or 320/640 ms. In the current NR system, anything above 20 ms may be considered as long SSB periodicity, and in the NTN system, the periodicity may be extended to a long periodicity, such as, for example 320 ms or 640 ms. In other example embodiments, the UE may be able to use less SSB samples when the network/tester increases the SSB periodicity, for instance, from regular 20 ms or NTN baseline SSB, to longer SSB periodicity, for instance, to 640 ms. In further example embodiments, in a test setup, the UE may be capable of performing time index reading with a reduced number of samples (e.g., single sample) when the radio conditions are above the side condition. In other example embodiments, handover delay may use one SSB for the time index reading.

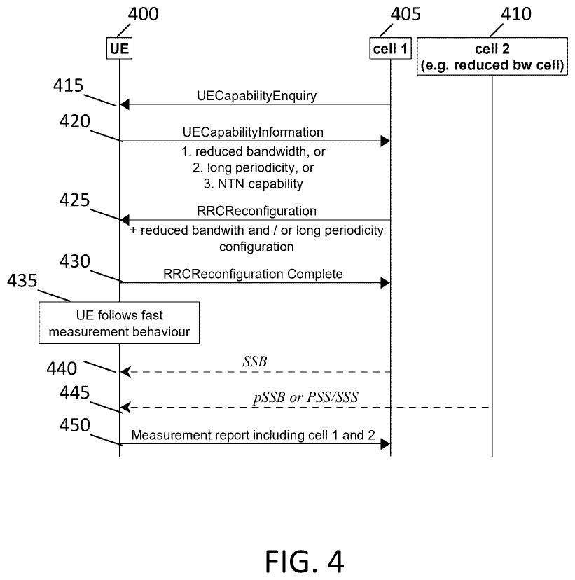

FIG. 4 illustrates an example of another signal flow diagram, according to certain example embodiments. At 415, cell 1 405 transmits a request/inquiry to the UE 400 for UE capability information. At 420, the UE 400 responds to the request from cell 1 405 by transmitting UE capability information. According to certain example embodiments, the UE capability information may include information that the UE is capable of operating under a reduced bandwidth of cell 2 410, that the UE is capable of being configured with a long SSB periodicity (e.g., 320 ms or 640 ms in an NTN scenario), or that the UE includes NTN capability (e.g., capable of performing single shot measurements. At 425, cell 1 405 transmits an RRC reconfiguration to the UE 400 in response to receiving the UE capability information. In certain example embodiments, the RRC reconfiguration may include reduced bandwidth and/or the long periodicity configuration for configuring the UE to perform measurements under a reduced bandwidth, long periodicity, and/or NTN scenario.

At 435, the UE 400 follows fast measurement behavior to perform fast measurement similar to 335. At 440, cell 1 405 transmits an SSB to the UE 400, and at 445, cell 2 410 transmits pSSB or PSS/SSS to the UE 400. In cell 1 405, the SSB or pSSB may also be a smaller bandwidth reference signal than the regular SSB. For example, the bandwidth may be reduced, but the signal may be extended in the time domain (i.e., more slots may be used). At 450, the UE 400 performs fast measurement of the SSB, pSSB, or PSS/SSS according to the RRC configuration received at 425, and transmits a measurement report which may include, for example, RSRP/RSRQ values of the measurements performed on cell/beam 1 405 and cell/beam 2 410.

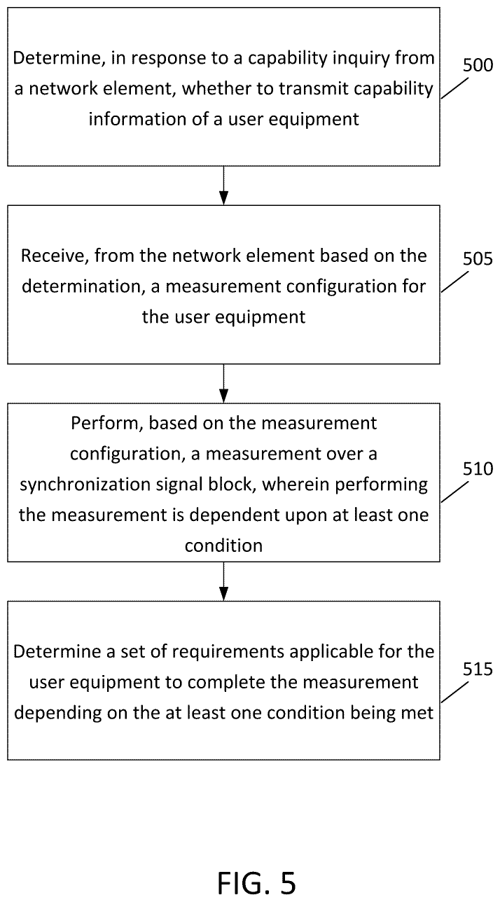

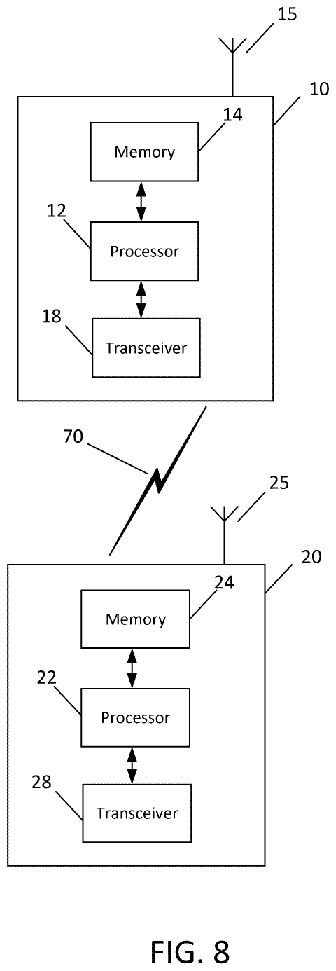

FIG. 5 illustrates an example flow diagram of a method, according to certain example embodiments. In an example embodiment, the method of FIG. 5 may be performed by a network entity, or a group of multiple network elements in a 3GPP system, such as LTE or 5G-NR. For instance, in an example embodiment, the method of FIG. 5 may be performed by a UE, similar to one of apparatuses 10 or 20 illustrated in FIG. 8.

As illustrated in FIG. 5, the method may include, at 500 determining, in response to a capability inquiry from a network element, whether to transmit capability information of a user equipment. The method may also include, at 505, receiving, from the network element based on the determination, a measurement configuration for the user equipment. The method may further include, at 510, performing, based on the measurement configuration, a measurement over a synchronization signal block, wherein performing the measurement is dependent upon at least one condition. In addition, the method may include, at 515, determining a set of requirements applicable for the user equipment to complete the measurement depending on the at least one condition being met.

According to certain example embodiments, the method may also include transmitting, to the network element based on the determining, the capability information. According to some example embodiments, the capability information may include a fast measurement capability of the user equipment. According to other example embodiments, the measurement configuration may include configuration for the apparatus to perform a fast measurement.

In certain example embodiments, the fast measurement may be a measurement that is completed by the apparatus in a shorter requirement for time to complete the measurement than a predefined requirement. In some example embodiments, a requirement to complete the measurement may be measured as a function of a number of periods of synchronization signal block transmission. In other example embodiments, the method may also include transmitting, to the network element, a measurement report of the synchronization signal block based on the measurement.

According to certain example embodiments, the at least one condition may include at least one of when a radio condition between the network element and the user equipment is greater than a predefined radio condition, the user equipment supports soft combining of measurements, or power boosting of a non-punctured part of the synchronization signal block is assumed. According to some example embodiments, a requirement to perform the fast measurement may be dependent upon a dedicated network configuration for fast measurement. According to other example embodiments, the dedicated network configuration may include at least one of a management object for fast measurement configuration, a list of carriers to which fast measurements are configured, or a configuration that the user equipment is performing fast measurements in a bandwidth that is less than 5 MHz.

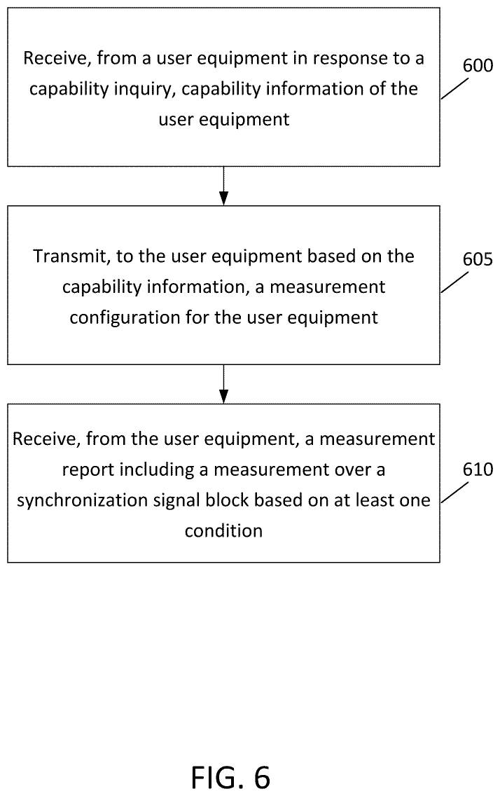

FIG. 6 illustrates an example flow diagram of another method, according to certain example embodiments. In an example embodiment, the method of FIG. 6 may be performed by a network entity, or a group of multiple network elements in a 3GPP system, such as LTE or 5G-NR. For instance, in an example embodiment, the method of FIG. 6 may be performed by a UE, similar to one of apparatuses 10 or 20 illustrated in FIG. 8.

As illustrated in FIG. 6, the method may include, at 600, receiving, from a user equipment in response to a capability inquiry, capability information of the user equipment. The method may also include, at 605, transmitting, to the user equipment based on the capability information, a measurement configuration for the user equipment. The method may further include, at 610, receiving, from the user equipment, a measurement report including a measurement over a synchronization signal block based on at least one condition.

According to certain example embodiments, the method may also include receiving the capability information from the user equipment. According to some example embodiments, the capability information may include a fast measurement capability of the user equipment. According to other example embodiments, the measurement configuration may include configuration for the user equipment to perform a fast measurement.

In certain example embodiments, the fast measurement may be a measurement that is completed by the user equipment in a shorter requirement for time to complete the measurement than a predefined requirement. In some example embodiments, a requirement to complete the measurement may be measured as a function of a number of periods of synchronization signal block transmission. In other example embodiments, the at least one condition may include at least one of when a radio condition between the network element and the user equipment is greater than a predefined radio condition, the user equipment supports soft combining of measurements, or power boosting of a non-punctured part of the synchronization signal block is assumed.

According to certain example embodiments, a requirement to perform the fast measurement may be dependent upon a dedicated network configuration for fast measurement. According to some example embodiments, the dedicated network configuration may include at least one of a management object for fast measurement configuration, a list of carriers to which fast measurements are configured, or a configuration that the user equipment is performing fast measurements in a bandwidth that is less than 5 MHz.

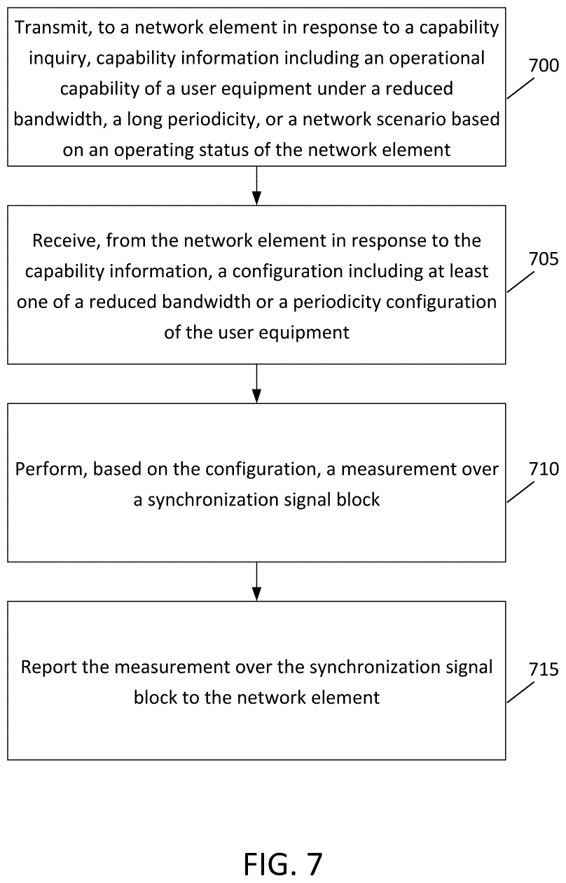

FIG. 7 illustrates an example flow diagram of a further method, according to certain example embodiments. In an example embodiment, the method of FIG. 7 may be performed by a network entity, or a group of multiple network elements in a 3GPP system, such as LTE or 5G-NR. For instance, in an example embodiment, the method of FIG. 7 may be performed by a UE, similar to one of apparatuses 10 or 20 illustrated in FIG. 8.

As illustrated in FIG. 7, the method may include, at 700, transmitting, to a network element in response to a capability inquiry, capability information including an operational capability of a user equipment under a reduced bandwidth, a long periodicity, or a network scenario based on an operating status of the network element. The method may also include, at 705, receiving, from the network element in response to the capability information, a configuration including at least one of a reduced bandwidth or a periodicity configuration of the user equipment. The method may further include, at 710, performing, based on the configuration, a measurement over a synchronization signal block. In addition, the method may include, at 715, reporting the measurement over the synchronization signal block to the network element.

According to certain example embodiments, the operating status of the network element may include operating on a 12 physical resource block synchronization signal block. According to some example embodiments, the periodicity configuration of the user equipment may include a synchronization signal block periodicity of 320 ms or 640 ms in a non-terrestrial network. According to other example embodiments, the report of the measurement may be performed based on satisfaction of a side condition between the network element and the user equipment.

In certain example embodiments, the side condition may include a value of 6 dB, −4 dB, or −2 dB. In some example embodiments, the measurement reporting procedure may include a single shot measurement procedure. In other example embodiments, the measurement may be performed by implementing a receiver chain to satisfy a single shot measurement criterion.

According to certain example embodiments, the method may also include maintaining synchronization with the network element by performing a single shot measurement at every synchronization signal block periodicity. According to some example embodiments, the method may further include performing a soft combining. According to other example embodiments, the soft combining may include storing a previous sample and performing extra receiver processing when a previous and a current synchronization signal block measurement is within a predefined margin.

FIG. 8 illustrates a set of apparatuses 10 and 20 according to certain example embodiments. In certain example embodiments, apparatuses 10 and 20 may be elements in a communications network or associated with such a network. For example, apparatus 10 may be a UE, or other similar radio communication computer device, and apparatus 20 may be a cell, BS, gNB, network, or other similar computing device.

In some example embodiments, apparatuses 10 and 20 may include one or more processors, one or more computer-readable storage medium (for example, memory, storage, or the like), one or more radio access components (for example, a modem, a transceiver, or the like), and/or a user interface. In some example embodiments, apparatuses 10 and 20 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatuses 10 and 20 may include components or features not shown in FIG. 8.

As illustrated in the example of FIG. 8, apparatuses 10 and 20 may include or be coupled to a processor 12 and 22 for processing information and executing instructions or operations. Processors 12 and 22 may be any type of general or specific purpose processor. In fact, processors 12 and 22 may include one or more of general-purpose computers, special purpose computers, microprocessors, DSPs, field-programmable gate arrays (FPGAs), application-specific integrated circuits (ASICs), and processors based on a multi-core processor architecture, as examples. While a single processor 12 and 22 is shown in FIG. 8, multiple processors may be utilized according to other example embodiments. For example, it should be understood that, in certain example embodiments, apparatuses 10 and 20 may include two or more processors that may form a multiprocessor system (e.g., in this case processors 12 may represent a multiprocessor) that may support multiprocessing. According to certain example embodiments, the multiprocessor system may be tightly coupled or loosely coupled (e.g., to form a computer cluster).

Processors 12 and 22 may perform functions associated with the operation of apparatuses 10 and 20 including, as some examples, precoding of antenna gain/phase parameters, encoding and decoding of individual bits forming a communication message, formatting of information, and overall control of the apparatuses 10 and 20, including processes and examples illustrated in FIGS. 1-7.

Apparatuses 10 and 20 may further include or be coupled to a memories 14 and 24 (internal or external), which may be respectively coupled to processors 12 and 24 for storing information and instructions that may be executed by processors 12 and 24. Memories 14 and 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memories 14 and 24 can be comprised of any combination of random access memory (RAM), read only memory (ROM), static storage such as a magnetic or optical disk, hard disk drive (HDD), or any other type of non-transitory machine or computer readable media. The instructions stored in memories 14 and 24 may include program instructions or computer program code that, when executed by processors 12 and 22, enable the apparatuses 10 and 20 to perform tasks as described herein.

In certain example embodiments, apparatuses 10 and 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processors 12 and 22 and/or apparatuses 10 and 20 to perform any of the methods and examples illustrated in FIGS. 1-7.

In some example embodiments, apparatuses 10 and 20 may also include or be coupled to one or more antennas 15 and 25 for receiving a downlink signal and for transmitting via an UL from apparatuses 10 and 20. Apparatuses 10 and 20 may further include a transceivers 18 and 28 configured to transmit and receive information. The transceivers 18 and 28 may also include a radio interface (e.g., a modem) coupled to the antennas 15 and 25. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an UL.

For instance, transceivers 18 and 28 may be configured to modulate information on to a carrier waveform for transmission by the antennas 15 and 25 and demodulate information received via the antenna 15 and 25 for further processing by other elements of apparatuses 10 and 20. In other example embodiments, transceivers 18 and 28 may be capable of transmitting and receiving signals or data directly. Additionally or alternatively, in some example embodiments, apparatus 10 may include an input and/or output device (I/O device). In certain example embodiments, apparatuses 10 and 20 may further include a user interface, such as a graphical user interface or touchscreen.

In certain example embodiments, memories 14 and 34 store software modules that provide functionality when executed by processors 12 and 22. The modules may include, for example, an operating system that provides operating system functionality for apparatuses 10 and 20. The memory may also store one or more functional modules, such as an application or program, to provide additional functionality for apparatuses 10 and 20. The components of apparatuses 10 and 20 may be implemented in hardware, or as any suitable combination of hardware and software. According to certain example embodiments, apparatuses 10 and 20 may optionally be configured to communicate each other (in any combination) via a wireless or wired communication links 70 according to any radio access technology, such as NR.

According to certain example embodiments, processors 12 and 22 and memories 14 and 24 may be included in or may form a part of processing circuitry or control circuitry. In addition, in some example embodiments, transceivers 18 and 28 may be included in or may form a part of transceiving circuitry.

For instance, in certain example embodiments, apparatus 10 may be controlled by memory 14 and processor 12 to determine, in response to a capability inquiry from a network element, whether to transmit capability information of the apparatus. Apparatus 10 may also be controlled by memory 14 and processor 12 to receive, from the network element based on the determination, a measurement configuration for the user equipment. Apparatus 10 may further be controlled by memory 14 and processor 12 to perform, based on the measurement configuration, a measurement over a synchronization signal block, wherein performing the measurement is dependent upon at least one condition. In addition, apparatus 10 may be controlled by memory 14 and processor 12 to determine a set of requirements applicable for the apparatus to complete the measurement depending on the at least one condition being met.

In other example embodiments, apparatus 20 may be controlled by memory 24 and processor 22 to receive, from a user equipment in response to a capability inquiry, capability information of the user equipment. Apparatus 20 may also be controlled by memory 24 and processor 22 to transmit, to the user equipment based on the capability information, a measurement configuration for the user equipment. Apparatus 20 may further be controlled by memory 24 and processor 22 to receive, from the user equipment, a measurement report including a measurement over a synchronization signal block based on at least one condition.

In other example embodiments, apparatus 10 may be controlled by memory 14 and processor 12 to transmit, to a network element in response to a capability inquiry, capability information including an operational capability of the apparatus under a reduced bandwidth, a long periodicity, or a network scenario based on an operating status of the network element. Apparatus 10 may also be controlled by memory 14 and processor 12 to receive, from the network element in response to the capability information, a configuration including at least one of a reduced bandwidth or a periodicity configuration of the apparatus. Apparatus 10 may further be controlled by memory 14 and processor 12 to perform, based on the configuration, a measurement over a synchronization signal block. In addition, apparatus 10 may be controlled by memory 14 and processor 12 to report the measurement over the synchronization signal block to the network element.

In some example embodiments, an apparatus (e.g., apparatus 10 and/or apparatus 20) may include means for performing a method, a process, or any of the variants discussed herein. Examples of the means may include one or more processors, memory, controllers, transmitters, receivers, and/or computer program code for causing the performance of the operations.

Certain example embodiments may be directed to an apparatus that includes means for performing any of the methods described herein including, for example, means for determining, in response to a capability inquiry from a network element, whether to transmit capability information of the apparatus. The apparatus may also include means for receiving, from the network element based on the determination, a measurement configuration for the user equipment. The apparatus may further include means for performing, based on the measurement configuration, a measurement over a synchronization signal block, wherein performing the measurement is dependent upon at least one condition. In addition, the apparatus may include means for determining a set of requirements applicable for the apparatus to complete the measurement depending on the at least one condition being met.

Other example embodiments may be directed to an apparatus that includes means for performing any of the methods described herein including, for example, means for receiving, from a user equipment in response to a capability inquiry, capability information of the user equipment. The apparatus may also include means for transmitting, to the user equipment based on the capability information, a measurement configuration for the user equipment. The apparatus may further include means for receiving, from the user equipment, a measurement report including a measurement over a synchronization signal block based on at least one condition.

Other example embodiments may be directed to an apparatus that includes means for performing any of the methods described herein including, for example, means for transmitting, to a network element in response to a capability inquiry, capability information including an operational capability of the apparatus under a reduced bandwidth, a long periodicity, or a network scenario based on an operating status of the network element. The apparatus may also include means for receiving, from the network element in response to the capability information, a configuration including at least one of a reduced bandwidth or a periodicity configuration of the apparatus. The apparatus may further include means for performing, based on the configuration, a measurement over a synchronization signal block. In addition, the apparatus may include means for reporting the measurement over the synchronization signal block to the network element.

Certain example embodiments described herein provide several technical improvements, enhancements, and/or advantages. For instance, in some example embodiments, it may be possible to reduce the number of measurement samples when the UE supports fast measurement capability and/or is configured with fast measurement configuration. This allows better overall system performance in certain situations, such as handovers and initial access. Additional benefits of certain example embodiments are that the performance is guaranteed, which means that the network may base its implementation on the higher performing requirements. In other example embodiments, it may be possible to handle pruned SSBs, and signal detection in less than 5 MHz over NTN while still enabling the UE to complete measurements in a timely manner.

A computer program product may include one or more computer-executable components which, when the program is run, are configured to carry out some example embodiments. The one or more computer-executable components may be at least one software code or portions of it. Modifications and configurations required for implementing functionality of certain example embodiments may be performed as routine(s), which may be implemented as added or updated software routine(s). Software routine(s) may be downloaded into the apparatus.

As an example, software or a computer program code or portions of it may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality may be performed by hardware or circuitry included in an apparatus (e.g., apparatus 10 or apparatus 20), for example through the use of an application specific integrated circuit (ASIC), a programmable gate array (PGA), a field programmable gate array (FPGA), or any other combination of hardware and software. In yet another example embodiment, the functionality may be implemented as a signal, a non-tangible means that can be carried by an electromagnetic signal downloaded from the Internet or other network.

According to certain example embodiments, an apparatus, such as a node, device, or a corresponding component, may be configured as circuitry, a computer or a microprocessor, such as single-chip computer element, or as a chipset, including at least a memory for providing storage capacity used for arithmetic operation and an operation processor for executing the arithmetic operation.

One having ordinary skill in the art will readily understand that the disclosure as discussed above may be practiced with procedures in a different order, and/or with hardware elements in configurations which are different than those which are disclosed. Therefore, although the disclosure has been described based upon these example embodiments, it would be apparent to those of skill in the art that certain modifications, variations, and alternative constructions would be apparent, while remaining within the spirit and scope of example embodiments. Although the above embodiments refer to 5G NR and LTE technology, the above embodiments may also apply to any other present or future 3GPP technology, such as LTE-advanced, and/or fourth generation (4G) technology.

### Partial Glossary:

3GPP 3rd Generation Partnership Project
5G 5th Generation
5GCN 5G Core Network
5GS 5G System
AI Artificial Intelligence
BS Base Station
DL Downlink
eNB Enhanced Node B
E-UTRAN Evolved UTRAN
gNB 5G or Next Generation NodeB
LTE Long Term Evolution
LMF Location Management Function
NR New Radio
PBCH Physical Broadcast Channel
PSS Primary Synchronization Signal
SSB Synchronization Signal Block
SSS Secondary Synchronization Signal
UE User Equipment
UL Uplink

We claim:

1. An apparatus, comprising:
at least one processor; and
at least one memory storing instructions, wherein the instructions, when executed by the at least one processor, cause the apparatus at least to:
transmit, to a network element in response to a capability inquiry, capability information comprising an operational capability of the apparatus under a reduced bandwidth, a long periodicity, or a network scenario based on an operating status of the network element;
receive, from the network element in response to the capability information, a configuration comprising at least one of a reduced bandwidth or a periodicity configuration of the apparatus;
perform, based on the configuration, a measurement over a synchronization signal block; and
report the measurement over the synchronization signal block to the network element.

2. The apparatus according to claim 1, wherein the operating status of the network element comprises operating on a 12 physical resource block synchronization signal block.

3. The apparatus according to claim 1, wherein the periodicity configuration of the apparatus comprises a synchronization signal block periodicity of 320 ms or 640 ms in a non-terrestrial network.

4. The apparatus according to claim 1, wherein the report of the measurement is performed based on satisfaction of a side condition between the network element and the apparatus.

5. The apparatus according to claim 4, wherein the side condition comprises a value of 6 dB, −4 dB, or −2 dB.

6. The apparatus according to claim 1, wherein the measurement reporting procedure comprises a single shot measurement procedure.

7. The apparatus according to claim 1, wherein the measurement is performed by implementing a receiver chain to satisfy a single shot measurement criterion.

8. The apparatus according to claim 1, wherein the at least one memory stores instructions that when executed by the at least one processor, further cause the apparatus at least to:
maintain synchronization with the network element by performing a single shot measurement at every synchronization signal block periodicity.

9. The apparatus according to claim 1, wherein the at least one memory stores instructions that when executed by the at least one processor, further cause the apparatus at least to:
perform a soft combining, wherein the soft combining comprises storing a previous sample and performing extra receiver processing when a previous and a current synchronization signal block measurement is within a predefined margin.

10. A method, comprising:
transmitting, to a network element in response to a capability inquiry, capability information comprising an operational capability of a user equipment under a reduced bandwidth, a long periodicity, or a network scenario based on an operating status of the network element;
receiving, from the network element in response to the capability information, a configuration comprising at least one of a reduced bandwidth or a periodicity configuration of the user equipment; and
performing, based on the configuration, a measurement over a synchronization signal block; and
reporting the measurement over the synchronization signal block to the network element.

11. The method according to claim 10, wherein the operating status of the network element comprises operating on a 12 physical resource block synchronization signal block.

12. The method according to claim 10, wherein the periodicity configuration of the user equipment comprises a synchronization signal block periodicity of 320 ms or 640 ms in a non-terrestrial network.

13. The method according to claim 10, wherein the report of the measurement is performed based on satisfaction of a side condition between the network element and the user equipment.

14. The method according to claim 10, wherein the side condition comprises a value of 6 dB, −4 dB, or −2 dB.

15. The method according to claim 10, wherein the measurement reporting procedure comprises a single shot measurement procedure.

16. The method according to claim 10, wherein the measurement is performed by implementing a receiver chain to satisfy a single shot measurement criterion.

17. The method according to claim 10, further comprising:
maintaining synchronization with the network element by performing a single shot measurement at every synchronization signal block periodicity.

18. The method according to claim 10, further comprising:
performing a soft combining, wherein the soft combining comprises storing a previous sample and performing extra receiver processing when a previous and a current synchronization signal block measurement is within a predefined margin.

19. A non-transitory computer readable medium encoded with instructions that, when executed in hardware, performs a process, the process comprising:
transmitting, to a network element in response to a capability inquiry, capability information comprising an operational capability of a user equipment under a reduced bandwidth, a long periodicity, or a network scenario based on an operating status of the network element;
receiving, from the network element in response to the capability information, a configuration comprising at least one of a reduced bandwidth or a periodicity configuration of the user equipment; and
performing, based on the configuration, a measurement over a synchronization signal block; and
reporting the measurement over the synchronization signal block to the network element.
